(19) United States
(12) Patent Application Publication
(10) Pub. No.: US 2014/0075220 A1
(43) Pub. Date: Mar. 13, 2014

(54) METHOD AND DEVICE OF CONTROLLING POWER SAVING

(71) Applicant: Tencent Technology (Shenzhen) Company Limited, Shenzhen (CN)

(72) Inventor: Jiashun SONG, Shenzhen (CN)

(73) Assignee: Tencent Technology (Shenzhen) Company Limited, Shenzhen (CN)

(21) Appl. No.: 14/079,592

(22) Filed: Nov. 13, 2013

Related U.S. Application Data
(63) Continuation of application No. PCT/CN2013/081450, filed on Aug. 14, 2013.

(30) Foreign Application Priority Data
Aug. 16, 2012 (CN) 201210292176.X

(51) Int. Cl. G06F 1/32

(52) U.S. Cl. CPC G06F 1/3212; G06F 1/3234
USPC 713/320

(57) ABSTRACT

Disclosed in the present invention are a method and a device for controlling power saving. The method comprises: monitoring an amount of remaining charge in a battery of a mobile device; and automatically adjusting a operation of the mobile device according to the monitored amount of remaining charge of the battery, the automatic adjusting comprising at least one of: changing a current value of a device parameter of the mobile device according to the monitored amount of remaining charge, and determining whether to turn off a user application and/or a device function that is currently active on the mobile device according to the monitored amount of remaining charge, so as to reduce the consumption of electricity from the battery.

### RELATED APPLICATIONS

This application is a continuation application of PCT Patent Application No. PCT/CN2013/081450, entitled “METHOD AND DEVICE OF CONTROLLING POWER SAVING”, filed on Aug. 14, 2013, which claims priority to Chinese Patent Application No. 201210292176.X, “METHOD AND DEVICE OF CONTROLLING POWER SAVING,” filed on Aug. 16, 2012, both of which are hereby incorporated by reference in their entirety.

### TECHNICAL FIELD

The present invention relates to the technical field of mobile devices, and particularly, to a method and a device for controlling power saving.

### BACKGROUND ART

A mobile device is generally fitted with a battery internally, and the battery can ensure that the device can operate normally in the case of no external power supply. The presence of the battery enables a mobile device such as a mobile phone, a laptop, a tablet computer or a PDA (personal digital assistant), etc. to move freely without being affected by an external power line, which provides a significant amount of convenience for the life and work of a user.

However, if the amount of remaining charge carried in the battery is depleted, the battery will not be able to supply power for the device, which will, to some extent, bring inconvenience to a user. For example, when a user is making a call using a mobile phone, run-out of the charge carried in the battery of the mobile phone will result in a forced interruption of the call, which affects the usage experience of the user. Then, how to conserve the amount of remaining charge in a battery of a mobile device, such that the battery may supply power for the mobile device for a longer time in certain scenarios (such as when the external power supply cannot be connected in time while the mobile device must be used away from a charging outlet) is becoming more important.

### SUMMARY

In order to solve the problems in the prior art, the embodiments of the present invention provide a method and device for controlling power saving. The technical solution is as follows:

On one hand, the present invention provides a method for controlling power saving, the method comprising: monitoring a current amount of remaining charge in a battery of a mobile device; and adjusting, automatically, without user intervention, a respective operation of the mobile device according to the monitored current amount of remaining charge, the adjusting comprising at least one of: changing a current value of a respective device parameter of the mobile device, determining whether to turn off a respective user application that is currently active on the mobile device, and determining whether to turn off a respective device function that is currently provided on the mobile device, automatically, without user intervention, according to the monitored amount of remaining charge, so as to reduce the consumption of electricity from the battery, with the device parameter including at least a screen display luminance and/or a screen standby time.

On the other hand, the present invention also provides a device for controlling power saving, the device comprising: a monitoring module and a control module, wherein the monitoring module is used for monitoring an amount of remaining charge in a battery of a mobile device; and the control module comprises: a first control unit for adjusting a device parameter of the mobile device according to the monitored amount of remaining charge; and/or a second control unit for determining whether or not to turn off a user application and/or device function that is currently active on the mobile device according to the monitored amount of remaining charge, so as to reduce the consumption of electricity from the battery, with the device parameter including at least a screen display luminance and/or a screen standby time.

The beneficial effects brought by the technical solution provided in the embodiments of the present invention are: by way of realizing the technical solution of monitoring the amount of remaining charge in a battery of a mobile device; and adjusting a device parameter of the mobile device according to the monitored amount of remaining charge, and/or determining whether or not to turn off a user application and/or device function that is currently active on the mobile device according to the monitored amount of remaining charge, with the device parameter including at least a screen display luminance and/or a screen standby time, the object of power saving can be accomplished by automatically adjusting settings which consume electricity, such as the screen display luminance and/or the screen standby time, and others, and/or the object of power saving can be accomplished by automatically determining whether or not to turn off an electricity-consuming user application and/or device function that is currently active, while the process of controlling power saving is fully controlled automatically according to the condition of the amount of remaining charge in the battery without any human being involved, and with manual operations being reduced.

### DESCRIPTION OF THE DRAWINGS

In order to more clearly illustrate the technical solution in the embodiments of the present invention, the figures to be used for describing the embodiments will be outlined hereinafter, and apparently, the figures described hereinafter are merely some embodiments of the present invention, and for those skilled in the art, other figures can be obtained according to these figures without any inventive efforts.

FIG. 1 is a schematic flowchart of a method for controlling power saving provided in accordance with some embodiments;

FIG. 2 is a schematic flowchart of a method for controlling power saving provided in accordance with some embodiments;

FIG. 3 is a structural schematic diagram of a device for controlling power saving in accordance with some embodiments;

FIG. 4 is a structural schematic diagram of a device for controlling power saving provided in accordance with some embodiments;

FIG. 5 is a structural schematic diagram of a device for controlling power saving provided in accordance with some embodiments; and

FIG. 6 is a structural schematic diagram of a device for controlling power saving provided in accordance with some embodiments.

FIGS. 7A-7C are exemplary user interfaces for controlling power saving in accordance with some embodiments.

FIG. 8 is a block diagram of an exemplary device for controlling power saving in accordance with some embodiments.

### DETAILED DESCRIPTIONS

In order to make the objects, technical solution and advantages of the present invention more clear, the embodiments of the present invention will be further described in detail in conjunction with the accompanying drawings.

### Embodiment I

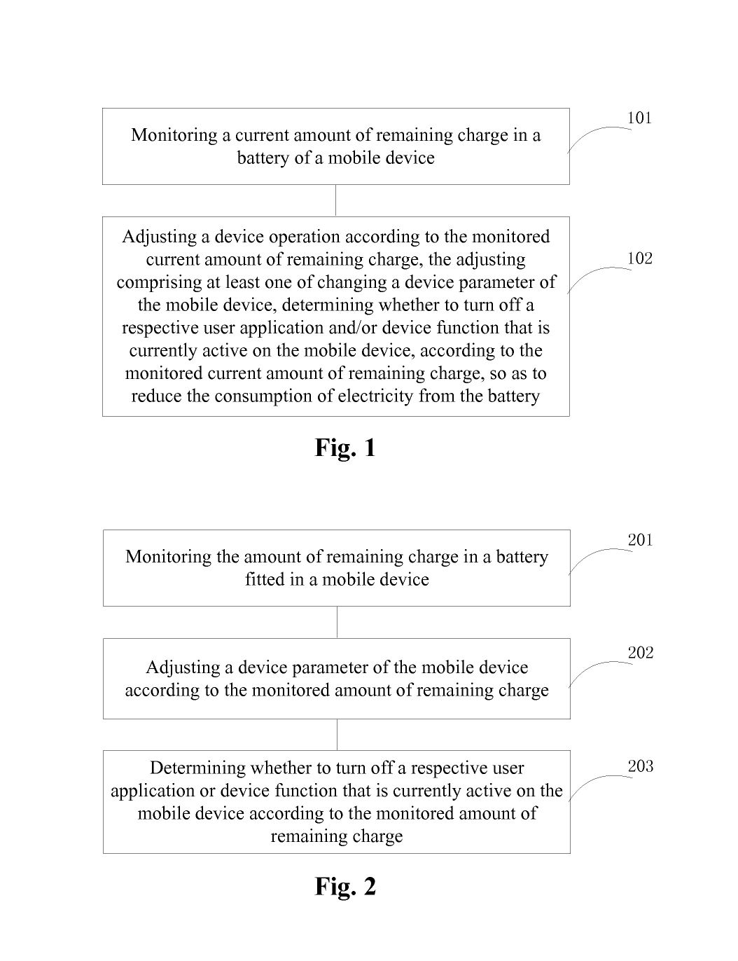

As shown in FIG. 1, a method for controlling power saving comprises:

Step 101: monitoring a current amount of remaining charge in a battery of a mobile device; and

Step 102: adjusting, automatically, without user intervention, a device operation according to the monitored current amount of remaining charge, the adjusting comprising at least one of: changing a current value of a respective device parameter of the mobile device according to the monitored current amount of remaining charge, determining whether or not to turn off a respective user application that is currently active on the mobile device according to the monitored current amount of remaining charge, and determining whether or not to turn off a respective device function that is currently active on the mobile device according to the monitored current amount of remaining charge, so as to reduce the consumption of electricity from the battery, with the device parameter including at least a screen display luminance and/or a screen standby time.

In some embodiments, the respective device parameter of the mobile device includes at least one of a screen display luminance and a screen standby time, and changing the current value of the respective device parameter of the mobile device comprises setting a current screen display luminance or a current screen standby time in accordance with a predetermined function of the monitored current amount of remaining charge.

In some embodiments, changing the current value of the respective device parameter of the mobile device according to the monitored current amount of remaining charge in the battery further comprises: in accordance with a determination that the monitored current amount of remaining charge is less than a pre-determined threshold value, setting the current value of the respective device parameter of the mobile device to a predetermined minimum parameter value; and obtaining a predetermined value of the respective device parameter corresponding to the monitored current amount of remaining charge by looking up a correspondence between the amount of remaining charge and the device parameter using the monitored current amount of remaining charge, and changing the current value of the respective device parameter of the mobile device to the obtained predetermined value of the respective device parameter.

In some embodiments, determining whether to turn off the respective user application on the mobile device that is currently active on the mobile device according to the monitored current amount of remaining charge in the battery further comprises: turning off the respective user application that is currently active on the mobile device in accordance with a determination that the monitored current amount of remaining charge is less than a pre-determined threshold value; and keeping a respective turned-on state of the respective user application that is currently active on the mobile device unchanged in accordance with a determination that the monitored current amount of remaining charge is not less than the pre-determined threshold value.

In some embodiments, the respective device function comprises at least one of Bluetooth, WiFi, and cellular data network communication functions, and determining whether to turn off the respective device function on the mobile device according to the monitored current amount of remaining charge in the battery further comprises: turning off the respective device function that is currently active on the mobile device in accordance with a determination that the monitored current amount of remaining charge is less than a pre-determined threshold value; and keeping a respective turned-on state of the respective application that is currently active on the mobile device unchanged in accordance the monitored current amount of remaining charge is not less than the pre-determined threshold value.

In some embodiments, the method further comprises: providing a modification interface to a user that facilitates the user in modifying an existing relationship or establishing a new relationship between the respective operation and a current status of the battery.

In some embodiments, turning off the respective user application that is currently active on the mobile device comprises: checking a respective setting state of the user application that is currently active on the mobile device; keeping a respective turned-on state of the respective user application that is currently active on the mobile device unchanged in accordance with a determination that the respective setting state of the user application is a turning-off-prohibited state; and turning off the application that is currently active on the mobile device when the setting state is a turning-off-permitted state.

The beneficial effects brought by the technical solution provided in the embodiments of the present invention are: by way of realizing the technical solution of monitoring the amount of remaining charge in a battery of a mobile device; and adjusting a device parameter of the mobile device according to the monitored amount of remaining charge, and/or determining whether or not to turn off a user application and/or device function that is currently active on the mobile device according to the monitored amount of remaining charge, with the device parameter including at least a screen display luminance and/or a screen standby time, the object of power saving can be accomplished by automatically adjusting settings which consume electricity, such as the screen display luminance and/or the screen standby time, and others, and/or the object of power saving can be accomplished by automatically determining whether or not to turn off an electricity-consuming user application and/or device function that is currently active, while the process of controlling power saving is fully controlled automatically according to the condition of the amount of remaining charge in the battery without any human being involved, and with manual operations being reduced.

### Embodiment II

The embodiments of the present invention provide a method for controlling power saving. The executive body of the method may be a device fitted with a battery, such as a mobile phone, a laptop, a tablet computer or a PDA (personal digital assistant), and other mobile devices, and may also be a controller provided within the mobile device, which particularly comprises:

Step 201: monitoring the amount of remaining charge in a battery of a mobile device, wherein the amount of remaining charge refers to the current quantity of the electric charges carried in the battery, and generally the unit thereof is milli-ampere-hour (mAh).

Particularly, in some embodiments, an API (application programming interface) corresponding to the battery of the mobile device may be invoked in real time to read the current amount of remaining charge in the battery of the mobile device.

In the embodiments of the present invention, the monitored amount of remaining charge in the battery may be represented by the percentage of the maximum amount of stored charge in the battery. For example, the monitored amount of remaining charge in the battery is 80%, where the 80% refers to that the monitored amount of remaining charge is 80% of the maximum amount of stored charge of the battery (4400 mAh).

Step 202: adjusting a device parameter of the mobile device according to the monitored amount of remaining charge, wherein the device parameter may comprise but not be limited to a screen display luminance and/or a screen standby time.

In the embodiments of the present invention, the setting of the device parameter such as the screen display luminance and/or the screen standby time of the mobile device, etc. will affect the electricity consumption condition of the battery, e.g. the higher the screen display luminance of the mobile device is, the more the electricity consumption from the battery is, and accordingly, the lower the screen display luminance of the mobile device is, the less the electricity consumption from the battery is, which may accomplish the object of power saving. The longer the screen standby time of the mobile device is, the more the electricity consumption from the battery is, and accordingly, the shorter the screen standby time of the mobile device is, the less the electricity consumption from the battery is, which may accomplish the object of power saving. Therefore, the present invention may adjust a current value of a respective device parameter (e.g., screen display luminance or screen standby time) of a mobile device according to the monitored current amount of remaining charge, so as to reduce the electricity consumption from the battery, accomplishing the object of power saving.

In particular implementation, a pre-determine threshold value may be used to control whether to enter a power-saving control mode, e.g., using a pre-determined threshold value for the current amount of remaining charge to determine whether to adjust a device parameter of the mobile device according to the monitored current amount of remaining charge of the battery. On this basis, adjusting a device parameter of the mobile device according to the monitored current amount of remaining charge optionally comprises: adjusting, when the monitored amount of remaining charge is less than the pre-determined threshold value, the current value of the device parameter (e.g., screen display luminance, or screen standby time) of the mobile device to a predetermined minimum value (e.g., a minimum screen display luminance of 30% full luminance, or a minimum screen standby time of 5 seconds). The device parameter is kept constant at the predetermined minimum value until the monitored current amount of remaining charge increase above the predetermined threshold value again, e.g., through recharging. In addition, adjusting the device parameter according the monitored current amount of remaining charge further comprises: when the monitored current amount of remaining charge is not less than the pre-determined threshold value, searching or looking up a correspondence (e.g., mapping table or function) between the amount of remaining charge and the device parameter according to the monitored current amount of remaining charge, so as to obtain a desired current value for the device parameter corresponding to the monitored current amount of remaining charge, and then adjusting the current value of the device parameter of the mobile device to the obtained desired current value of the device parameter.

The technical solution mentioned above may adjust a device parameter of a mobile device by stages according to the monitored current amount of remaining charge, and control power saving in several different stages.

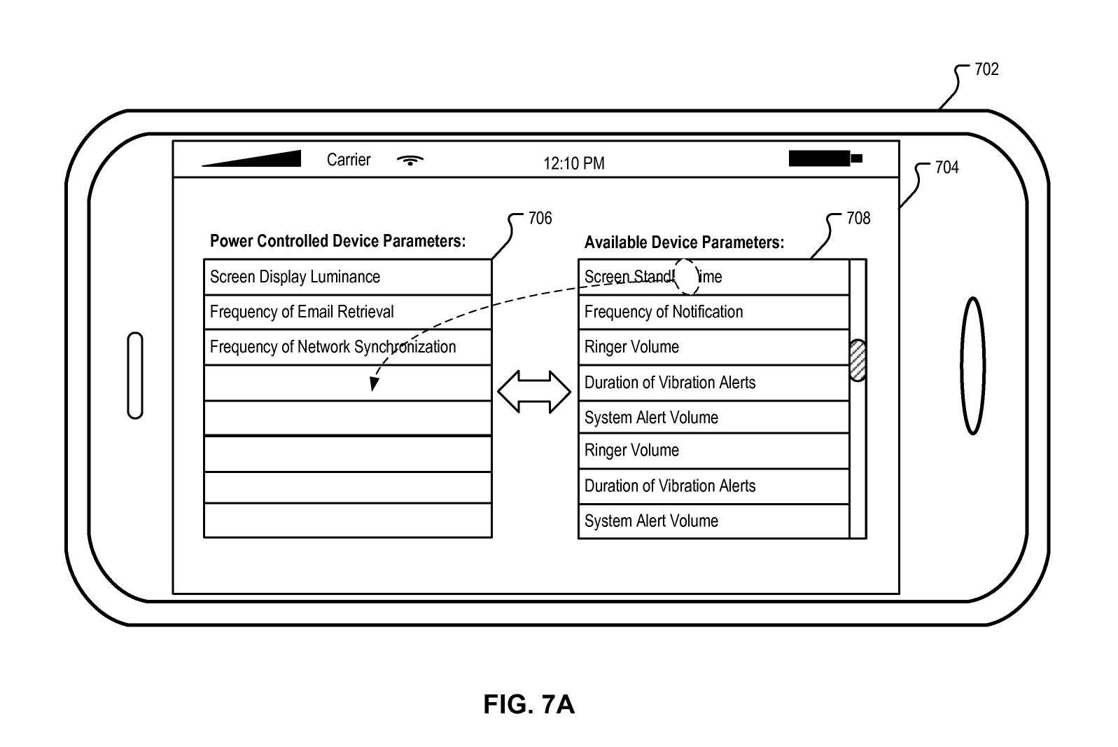

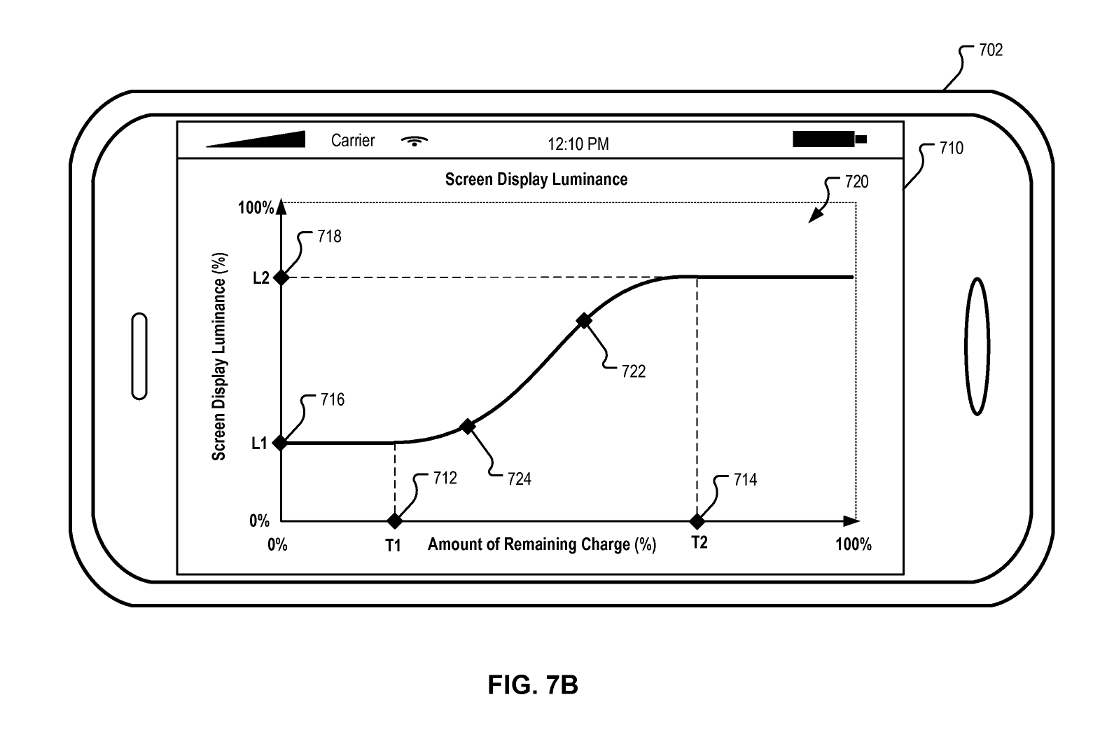

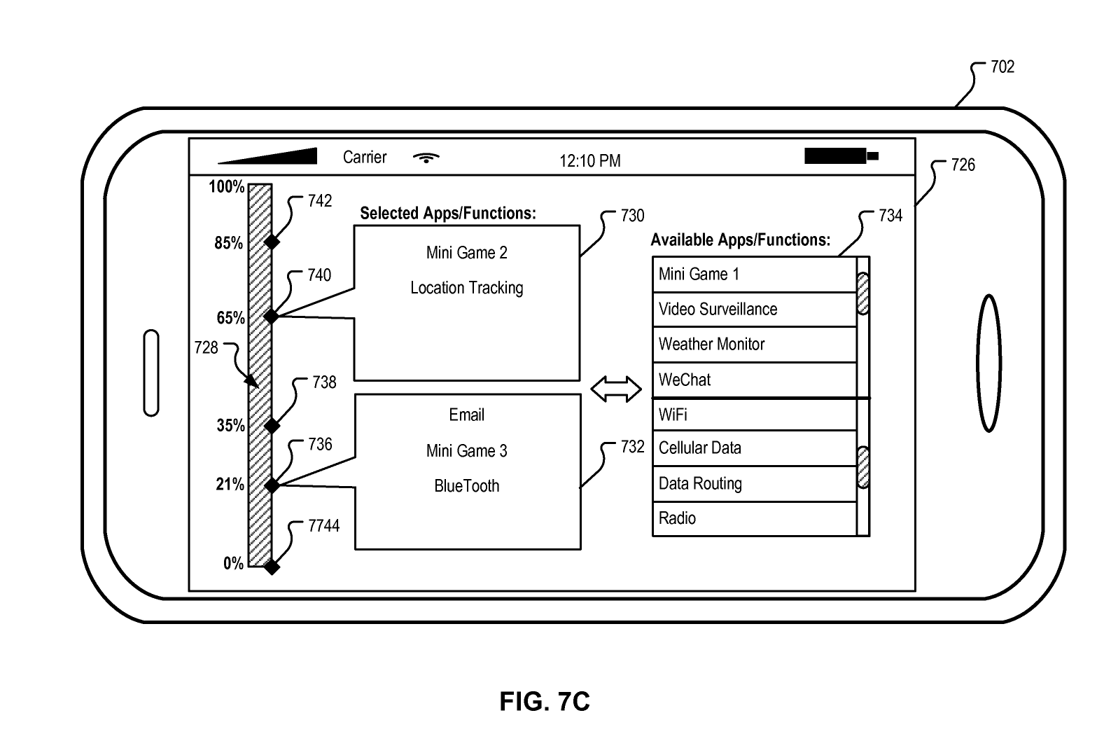

In the embodiments of the present invention, the pre-determined value may be pre-set by software, e.g. at 40% of full-charge. In particular implementations, a modification access (e.g., a modification user interface) may also be provided for a user so as to facilitate the user in modifying the pre-determined value via the modification access, e.g. the user may modify the 40% value to be 20% of full charge via the modification access. An exemplary modification user interface is provided in FIG. 7A-7C.

Here, providing a modification access for a user so as to realize man-machine interaction enables the user to satisfy the requirements of controlling power saving thereof by modifying the pre-determined value mentioned above. If the user wants to control power saving when the amount of remaining charge in the battery is 20% of full charge rather than controlling power saving when it is 40% of full charge, it may be realized by modifying the pre-determined value mentioned above via the modification access, which may further satisfy the requirements of the user and improve the usage experience of the user.

The process of controlling power saving mentioned above will be described by way of examples, which may particularly be as follows:

Here, the pre-determined value is set as 40% of full charge, and the device parameter is the screen display luminance of a mobile device.

When the monitored amount of remaining charge is 35% of full charge, which is less than the pre-determined value (e.g., 40% of full charge), the current screen display luminance of the mobile device will be adjusted to the predetermined minimum parameter value, e.g. 10% of full luminance. Here, a minimum parameter value of a device parameter may be generally set in advance. While the object of power saving can be accomplished, the consideration that the user vision will not be affected much is also ensured; thus setting the minimum value for the screen display luminance may be needed.

When the monitored amount of remaining charge is 45% of full charge, which is greater than the pre-determined value (e.g., 40% of full charge), the correspondence between the amount of remaining charge and the screen display luminance (as shown in Table 1) is searched, obtaining that the corresponding screen display luminance is 60% of full luminance when the monitored amount of remaining charge is 45% of full charge, thus adjusting the screen display luminance of the mobile device to 60% of full luminance.

When the monitored amount of remaining charge is 60% of full charge, which is greater than the pre-determined value (e.g., 40% of full charge), the correspondence between the amount of remaining charge and the screen display luminance (as shown in table 1) is searched, obtaining that the corresponding screen display luminance is 85% of full luminance when the monitored amount of remaining charge is 60% of full charge, thus adjusting the screen display luminance of the mobile device to 85% of full luminance.

TABLE 1

| Amount of remaining charge | Screen display luminance |
|---|---|
| 100%-95% | 100% |
| 94%-80% | 95% |
| 79%-70% | 90% |
| 69%-60% | 85% |
| . . . | . . . |
| 45%-40% | 60% |
| 39%-0 | 10% |

Furthermore, here, the pre-determined threshold value is set as 20% of full charge, and the device parameter is the screen standby time of a mobile device.

When the monitored amount of remaining charge is 15% of full charge, which is smaller than the pre-determined value (e.g., 20% of full charge), the current screen standby time of the mobile device is adjusted to the minimum parameter value, e.g., 2 seconds.

When the monitored amount of remaining charge is 30% of full charge, which is greater than the pre-determined threshold value, the correspondence between the amount of remaining charge and the screen standby time (as shown in table 2) is searched, obtaining that the corresponding screen standby time is 5 seconds when the monitored amount of remaining charge is 30% of full charge, thus adjusting the screen standby time of the mobile device to 5 seconds.

When the monitored amount of remaining charge is 70% of full charge, which is greater than the pre-determined threshold value (e.g., 20% of full charge), the correspondence between the amount of remaining charge and the screen standby time (as shown in Table 2) is searched, obtaining that the corresponding screen standby time is 30 seconds when the amount of remaining charge is 70% of full charge, thus adjusting the screen standby time of the mobile device to 30 seconds.

TABLE 2

| Amount of remaining charge | Screen standby time (s) |
|---|---|
| 100%-95% | 60 s |
| 94%-80% | 50 s |
| 79%-70% | 30 s |
| 69%-60% | 20 s |
| . . . | . . . |
| 30%-40% | 5 s |
| 19%-0 | 2 s |

Additionally, in particular implementations, a modification access (e.g., a modification user interface) may also be provided for a user, so as to facilitate the user in modifying the correspondence between the amount of remaining charge and the device parameter (e.g., the screen standby time or the screen display luminance) mentioned above via the modification access. For example, the corresponding screen display luminance can be modified from 60% to 65% of full luminance for the amount of remaining charge of 45%-40% of full charge in Table 1, etc. As such, the user may set the correspondence mentioned above according to his/her own needs, and improve the usage experience of the user. An exemplary user interface or creating and/or modifying the correspondence relationship between the amount of remaining charge and each of one or more device parameters are provided in FIGS. 7A-7C.

Step 203: determining whether to turn off a user application and/or a device function that is currently active on the mobile device according to the monitored amount of remaining charge, wherein the device function may comprise but not be limited to Bluetooth, wireless fidelity (WiFi) and/or cellular data network communication functions, and wherein the user application may comprise but not be limited to an application program that provides a graphical user interface that facilitate user interaction between the user and the mobile device. Here, the application program comprises IM (instant messenger) software, SNS (social networking services) software, the microblog, the wechat or a game program, etc. In some embodiments, an application program may employ one or more device functions (e.g., WiFi, Bluetooth, etc.) to accomplish one or more of its functions. In some embodiments, turning off an application program also comprises turning off the one or more device function(s) that are employed by the application program. In some embodiments, turning off an application program does not automatically include turning off the one or more device function(s) that are employed by the application program. In some embodiments, when turning off a user application, the power saving program also requests a user authorization for turning off the one or more device functions that are employed by the application program. If the user authorizes turning off the one or more device functions, then, the power saving program proceeds to turn off the one or more device functions. If the user does not authorize turning off the one or more device functions with the application program, the power saving program only turns off the application program, but leaves the one or more device functions turned on. In some embodiments, when a user application program (e.g., an email program) provide multiple functions (e.g., an email composition function, an email retrieval function, an email sending function, an email archiving function, etc.) that can be individually turned off, each function can be associated with a respective minimum battery level (e.g., 30% of full charge for the email composition function, 50% of full charge for the email retrieval function, 55% of full charge for the email sending function, an 70% if full charge for the email archiving function, etc). In general, a less critical function and/or a more power-intensive function of an application program can be associated with a higher minimum batter level. When the current amount of remaining charge falls below the respective minimum battery level associated with a particular function of the user application, the power saving program only turns off that particular function but leaves the other functions to continue to operate normally.

In the embodiments of the present invention, if the electricity consumption when the mobile device turns on the user application or device function mentioned above is higher than that when the user application or device function mentioned above is not turned on, then in order to accomplish the object of power saving, the user application or device function that is currently active on the mobile device may be turned off. For example, the device consumes much power when executing a power-intensive user application (a gaming application with high graphics and computation demand) or when providing a power-intensive device function (e.g., cellular data network or Bluetooth communication function). Turning off these power-intensity user applications and device functions on the mobile device can conserve power on the mobile device.

In particular implementations, likewise, a pre-determined threshold value may also be used to control whether to enter a power-saving control mode, e.g., using a pre-determined value to determine whether to turn off the user application or device function that is currently active on the mobile device according to the monitored amount of remaining charge. On this basis, determining whether to turn off the user application or device function that is currently active on the mobile device according to the monitored amount of remaining charge may comprise: turning off the user application and/or device function that is currently active on the mobile device when the monitored amount of remaining charge is less than a pre-determined threshold value; and keeping the turned-on state of the user application and/or device function that is currently active on the mobile device unchanged when the monitored amount of remaining charge is not less than the pre-determined threshold value. In some embodiments, the user can modify or establish different minimum threshold batter levels for different user applications and device functions. For example, a user may balance the needs for maintaining availability of a user application or device function and for conserving power on the mobile device, and set a lower threshold battery levels (e.g., 30%) for the more important user applications or device functions than the less important user applications or device functions, even if the more important user applications or device functions may also consume more power than the less important user applications or device functions. An exemplary user interface for creating and modifying the threshold battery levels for turning off one or more user applications and/or device functions on the mobile device is provided in FIGS. 7A-7C. In some embodiments, if a user application or device function is automatically turned off by the power saving program based on the current amount of remaining charge in the battery, the power saving program optionally turn on the user application or device function automatically when the current amount of remaining charge in the battery is restored (e.g., through recharging) to a level above its associated threshold value.

In addition, considering that some users have a great dependence on some user applications and/or device functions which are turned on, in order to avoid turning off, during power-saving control, some user applications and/or device functions on which a user has a great dependence, in particular implementations, the embodiments of the present invention may provide a state setting access (e.g., a modification user interface) for the user, such that the user may set the state of a user application or device function via the state setting access. Thus, whether to turn off a user application or device function that is currently active may be further controlled according to the setting state of the application during power-saving control. On this basis, the turning off the user application or device function that is currently active on the mobile device may comprise: checking the setting state of the user application or device function that is currently active on the mobile device; keeping the turned-on state of the user application or device function that is currently active on the mobile device unchanged if the setting state is a turning-off-prohibited state; and turning off the user application or device function that is currently active on the mobile device when the setting state is turning-off-permitted state.

In addition, it should be noted that, in particular implementation of the embodiments of the present invention, step 202 and step 203 (and the sub-steps for turning off the user application or the device function) may be selected in the alternative to realize the control strength of power-saving control, and step 202 and step 203 (and the sub-steps for turning off the user application or the device function) may also be used together. When implementing step 202 and step 203 simultaneously, the order of step 202 and step 203 needs not be restricted, and the embodiment of the present inventions does not particularly restrict this.

The beneficial effects brought by the technical solution provided in the embodiments of the present invention are: by way of realizing the technical solution of monitoring the amount of remaining charge in a battery of a mobile device; and adjusting a device parameter of the mobile device according to the monitored amount of remaining charge, and/or determining whether or not to turn off a user application and/or device function that is currently active on the mobile device according to the monitored amount of remaining charge, with the device parameter including at least a screen display luminance and/or a screen standby time, the object of power saving can be accomplished by automatically adjusting settings which consume electricity, such as the screen display luminance and/or the screen standby time, and others, and/or the object of power saving can be accomplished by automatically determining whether or not to turn off an electricity-consuming user application or device function that is currently turned on, while the process of controlling power saving is fully controlled automatically according to the condition of the amount of remaining charge in the battery without any human being involved, and with manual operations being reduced.

### Embodiment III

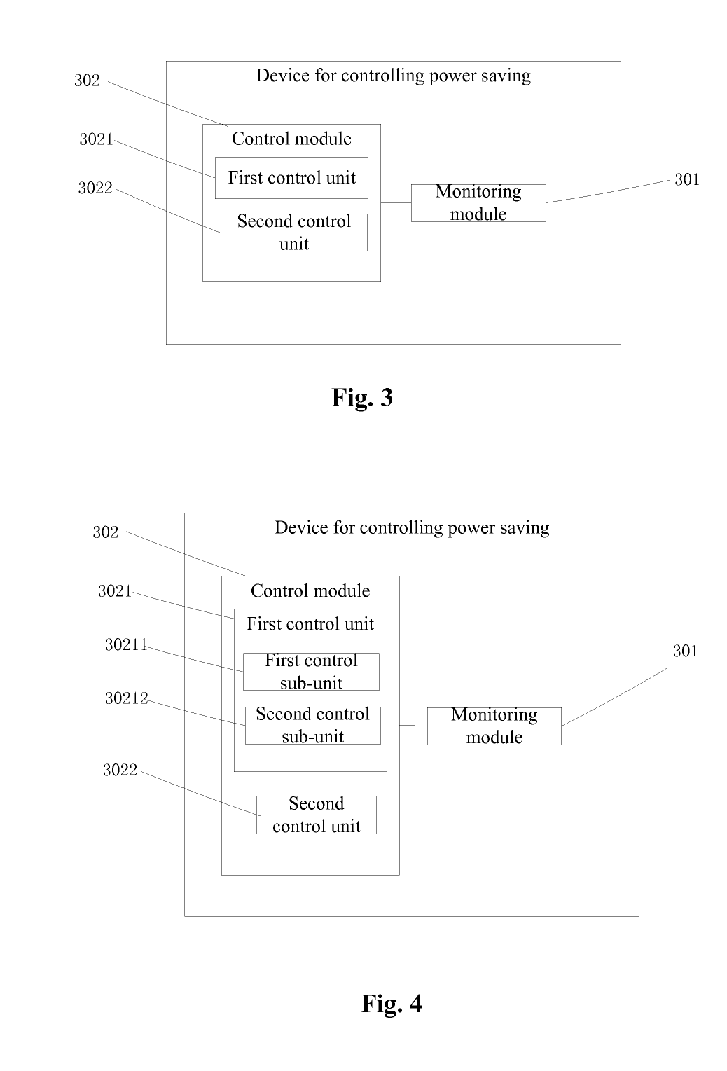

As shown in FIG. 3, the embodiments of the present invention provides a device for controlling power saving. The device may particularly be a user device or a controller in method embodiment II, comprising: a monitoring module 301 and a control module 302, wherein the monitoring module 301 is used for monitoring the amount of remaining charge in a battery of a mobile device; and the control module 302 comprises: a first control unit 3021 for adjusting a device parameter of the mobile device according to the monitored amount of remaining charge; and/or a second control unit 3022 for determining whether or not to turn off a user application and/or a device function that is currently active on the mobile device according to the monitored amount of remaining charge, so as to reduce the consumption of electricity from the battery, with the device parameter including at least a screen display luminance and/or a screen standby time.

Furthermore, as shown in FIG. 4, the first control unit 3021 as shown in FIG. 3 in the embodiments of the present invention comprises: a first control sub-unit 30211 for adjusting, when the monitored amount of remaining charge is less than a pre-determined threshold value, the device parameter of the mobile device to a predetermined minimum parameter value; and a second control sub-unit 30212 for searching, when the monitored amount of remaining charge is not less than the pre-determined value, a correspondence between the amount of remaining charge and the device parameter according to the monitored amount of remaining charge to obtain a device parameter corresponding to the monitored amount of remaining charge, and adjusting the current device parameter of the mobile device to the searched device parameter.

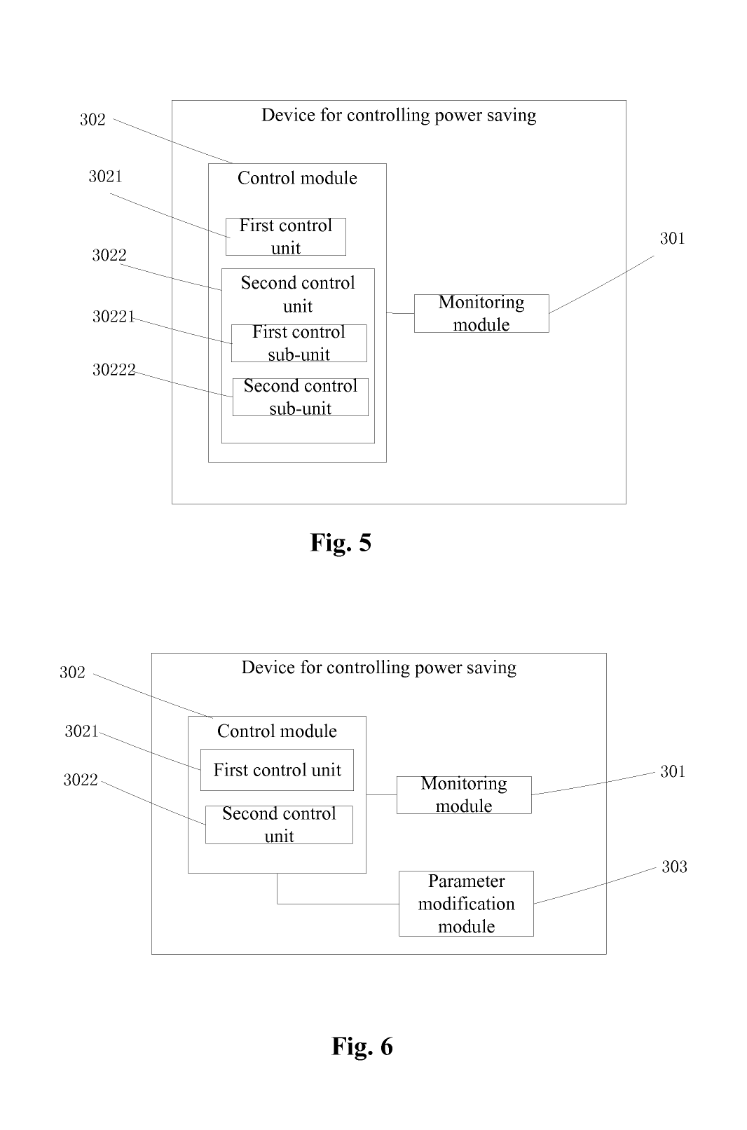

Furthermore, as shown in FIG. 5, the second control unit 3022 as shown in FIG. 3 in the embodiments of the present invention comprises: a first control sub-unit 30221 for turning off the user application and/or device function that is currently active on the mobile device when the monitored amount of remaining charge is less than a pre-determined value, wherein the device function at least includes Bluetooth, wireless fidelity (WiFi) and/or cellular data network communication functions, and the user application includes at least an application program that provides a graphical user interface for facilitating the interaction between the user and the mobile device; and a second control sub-unit 30222 for keeping the turned-on state of the user application and/or device function that is currently active on the mobile device unchanged when the monitored amount of remaining charge is not less than the pre-determined threshold value.

In the embodiments of the present invention, the first control sub-unit 30221 is particularly used for checking the setting state of the user application or device function that is currently active on the mobile device; keeping the turned-on state of the user application or device function that is currently active on the mobile device unchanged if the setting state is a turning-off-prohibited state; and turning off the user application or device function that is currently active on the mobile device when the setting state is a turning-off-permitted state.

Furthermore, as shown in FIG. 6, the device as shown in FIG. 3 in the embodiments of the present invention may further comprise: a parameter modification module 303 for providing a modification access (e.g., a modification user interface) to a user so as to facilitate the user in modifying the pre-determined threshold value via the modification access.

The beneficial effects brought by the technical solution provided in the embodiments of the present invention are: by way of realizing the technical solution of monitoring the amount of remaining charge in a battery fitted in a mobile device; and adjusting a device parameter of the mobile device according to the monitored amount of remaining charge, and/or determining whether or not to turn off a user application and/or device function that is currently active on the mobile device according to the monitored amount of remaining charge, with the device parameter including at least a screen display luminance and/or a screen standby time, the object of power saving can be accomplished by automatically adjusting settings which consume electricity, such as the screen display luminance and/or the screen standby time, and others, and/or the object of power saving can be accomplished by automatically determining whether or not to turn off an electricity-consuming user application or device function that is currently turned on, while the process of controlling power saving is fully controlled automatically according to the condition of the amount of remaining charge in the battery without any human being involved, and with manual operations being reduced.

It should be noted that: when the device for controlling power saving provided in the embodiments mentioned above controls power saving, illustration is only made according to the division of the various functional modules mentioned above, and in practical application, the functions mentioned above may be assigned to be completed by different functional modules as required, i.e. dividing the internal structure of the device into different functional modules to complete all or some of the above-described functions. In addition, the device for controlling power saving and the method for controlling power saving provided in the embodiments mentioned above belong to the same concept, and the particular implementation process thereof is seen in the method embodiments, which will not be repeated here.

FIGS. 7A-7C illustrate an exemplary modification user interface for creating and/or modifying respective relationships between the current status of the battery (e.g., the monitored current amount of remaining charge) and one or more device parameters, user applications and/or device functions on a mobile device 702. The exemplary modification user interfaces are also used for establishing and/or modifying the various threshold values for taking a power-saving action (e.g., setting a particular device parameter to a particular minimum value, determining whether to turn off a particular user application or device function, etc.).

As shown in FIG. 7A, a power saving program can be invoked on the mobile device 702 and executes in the background continuously to monitor the current amount of remaining charge in the battery of the mobile device, and automatically takes various power saving actions described above in accordance with the monitored current amount of remaining charge. In some embodiments, the power saving program provides an icon on the home screen of the mobile device 702, which when selected by the user, causes the power saving program to present a parameter selection interface 704 of the modification user interface. In the parameter selection interface 704 of the modification user interface, the user can select the device parameters whose values are to be modified in accordance with the monitored current amount of remaining charge in the battery, and establish the particular correspondence (e.g., mapping or functional relationship) between the parameters and the monitored current amount of remaining charge in the battery. As shown in FIG. 7A, the parameter selection interface 704 of the modification user interface includes a first display area 706 for presenting a set of device parameters that are currently controlled according to the current battery level, and a second display area 708 for presenting a set of device parameters that are currently not controlled according to the current battery level, but are available to be controlled according to the current battery level. For example, in the example shown in FIG. 7A, a device parameter “screen display luminance” is currently displayed in the first display area 706, indicating that the screen display luminance of the mobile device is controlled by the power saving program according to the current battery level. In addition, a device parameter “screen standby time” is currently displayed in the second display area 708, indicating that the screen standby time of the mobile device is currently not controlled by the power saving program according to the current battery level. When the user drags and drops a device parameter (e.g., “screen standby time”) from the second display area 708 to the first display area 706, the device parameter (e.g., “screen standby time”) will now be controlled by the power saving program according to the current battery level. Similarly, when the user drags and drops a device parameter (e.g., “screen display luminance”) from the first display area 706 to the second display area 708, the device parameter (e.g., “screen display luminance”) will no longer be controlled by the power saving program according to the current battery level, and will resume its default value. Other example device parameters that can be selectively controlled according to the current battery level to cause power saving includes sound level of system alert, duration of vibration alert, frequency of email retrieval, frequency of backup action, frequency of network synching action, frequency of notifications, display resolution, etc. In general, device parameters that can be varied gradually (e.g., increased and decreased in multiple stages) can be included in the second display area 708 of the parameter selection interface 704 for user selection.

In some embodiments, once a user has selected a particular device parameter currently displayed in the first display area 706 of the parameter selection interface 704, the modification user interface transitions into a relationship specification interface 710 for the selected device parameter. As shown in FIG. 7B, when the user has selected the “screen display luminance” parameter in the first display area 706 of the parameter selection interface 704, and the mobile device displays a parameter value-battery level relationship specification interface 704 for the selected “screen display luminance” parameter. As shown in FIG. 7B, in the relationship specification interface 710, a plot 720 showing the mapping or functional relationship is displayed. Control elements 712 and 714 are displayed in the plot for changing the minimum threshold battery level (T1) and the maximum threshold battery level (T2), where when the monitored current battery level drops below T1, the current value of the screen display luminance is set to a minimum threshold luminance (L1), and where when the monitored current battery level rises below T2, the current value of the screen display luminance is set to a maximum threshold luminance (L2). In addition, control elements 716 and 718 are displayed in the plot for changing the values for the minimum and the maximum threshold luminance L1 and L2, respectively. In some embodiments, the user can select a particular base functional relationship (e.g., linear, binomial, logarithmic, step, etc.) for the “screen display luminance” parameter and the current battery level from a list of available base functional relationship, and then modify the base functional relationship using various controls (e.g., controls 722 and 724) provided on the plot 720. For example, the user can grab and drag controls 712 and 714 along the axis for the battery level to change the values for T1 and T2, respectively. The user can also grab and drag the controls 716 and 718 along the axis for the screen luminance level to change the values for L1 and L2, respectively. When the values for any of L1, L2, T1, and T2 are modified by the user, the line segment between the values for L1 and L2, and T1 and T2 are also modified accordingly. When the user wishes to change the slope or inflection points along the line segment between the values for L1 and L2, and T1 and T2, the user can grab the controls 722 and 724 and morph the line segment to a desired shape. In some embodiments, once the user has finished manipulating the controls to modify the base functional relationship for the “screen display luminance” parameter, the correspondence between the parameter value and the battery level as reflected by the plot is recorded (e.g., in a look-up table) and subsequently used by the power saving program to control the screen display luminance of the device.

In some embodiments, the user can switch from the respective relationship specification interface for a currently selected device parameter to the respective relationship specification interface for another currently selected device parameter by providing a swiping gesture (e.g., to the left or to the right) on the relationship specification interface 710. In some embodiments, the user may provide a “Back” input to return to the parameter selection interface 702, and select another device parameter to modify. Although the example relationship shown in FIG. 7B is a smooth functional relationship, other mapping or functional relationships are possible. For example, a step function can be established for the “screen standby time” parameter, where the screen standby time is kept constant at a respective value for each of a plurality of battery level ranges (e.g., 0%-30%, 31%-60%, 61%-100%), and is only changed to a next value when a transition from one range to another range has occurred.

FIG. 7C illustrates an exemplary turn-off control interface 726 for specifying when and whether to turn off a respective user application or device function in accordance with a monitored current amount of remaining charge in the battery of the mobile device 702.

As shown in FIG. 7C, the mobile device displays a battery level indicator 728, one or more selected application/function windows (e.g., window 730 and window 732, and an available application/function window 734. The battery level indicator 728 includes one or more threshold indicators (e.g., threshold indicators 736, 738, 740, and 742). Each threshold indicator corresponds to a respective threshold battery level (e.g., 21%, 35%, 65%, and 85%) for turning off a respective group of user applications and/or device functions. In some embodiments, the user can adjust the threshold value associated with each threshold indicator by grabbing and dragging the threshold indicator up and down along the battery batter level indicator 728. In some embodiments, when the user taps on a particular threshold indicator (e.g., threshold indicator 740), a respective window (e.g., window 730) presenting a group of one or more user applications and/or device functions that are to be turned off when the monitored current battery level falls to the respective threshold battery level (e.g., 65% of full charge) associated with the particular threshold indicator (e.g., threshold indicator 740) will be displayed. In some embodiments, the user can select multiple threshold indicators (e.g., threshold indicators 740 and 736) and open multiple corresponding windows (e.g., windows 730 and 732) in the turn-off control interface 726. In some embodiments, the user can drag and drop a particular user application or device function from a selected application/function window (e.g., window 730) associated with a first threshold indicator (e.g., threshold indicator 740) to another selected application/function window (e.g., window 732) associated with a second threshold indicator (e.g., threshold indicator 736), so as to change the turn-off threshold battery level set for the particular user application or device function (e.g., from 65% to 21% of full charge). In addition, the user can also drag and drop a particular user application or device function from a selected application/function window (e.g., window 730) associated with a particular threshold indicator (e.g., threshold indicator 740) to the available application/function window 734, such that the particular user application is no longer turned off in accordance with the monitored current battery level by the power saving program. In addition, the user can also drag and drop a particular user application or device function from the available application/function window 734 to a respective selected application/function window (e.g., window 730) associated with a particular threshold indicator (e.g., threshold indicator 740), such that the particular user application or device function will be turned off in accordance with the monitored current battery level by the power saving program at the corresponding threshold battery level (e.g., 65% of full charge).

In some embodiments, the user can browse the list of available user application and/or functions (and/or individual sub-functions of user applications) in the available application/function window 734 by swiping up and down along the window 734. In some embodiments, the user applications and device functions represented in the window 734 are sorted according to their average power consumption levels. In some embodiments, the order by which the available user applications and/or device functions are sorted is affected by how frequently a user actively uses the particular user applications and/or device functions. For example, a less frequently used user application or device function can be placed closer to the top of the window 734, such that the user can drag and drop it into a corresponding selected application/function window of a threshold indicator. In some embodiments, the window 734 is split into two sub-windows, one for user applications and one for device functions.

In some embodiments, the user can create additional threshold battery levels or remove existing threshold battery levels using the battery level indicator 728. For example, when the user grabs and drags the threshold indicator 744 (shown at 0% of full charge) up along the battery level indicator, a new threshold indicator will be “torn off” from the threshold indicator 744 and presented on the battery level indicator 728. The user can place the new threshold indicator at the desired battery level value (e.g., 45%), opens a respective selected application/function window of the new threshold indicator, and drag and drop one or more user applications and/or device functions from the available application/function window 734 or from the corresponding selected application/function window of another threshold indicator.

In some embodiments, when the user drags an existing threshold indicator to and beyond the origin (e.g., the 0% level) or the maximum (e.g., 100% level) of the battery level indictor 728, the threshold indicator is removed from the turn-off specification interface 726. Accordingly, the group of user applications and/or device functions associated with the removed threshold indicator are returned to the available application/function window 734, and are no longer controlled according to the monitored current battery level.

In some embodiments, if the user drags and drops one existing threshold indicator over another existing threshold indicator, the two threshold hold indicators are merged into one, and the respective groups of selected user applications and/or device functions are also merged into a single group. All of the user applications and device functions in the merged group will be turned off, when the monitored current battery level falls to the threshold battery level associated with the merged level indicator.

The user interfaces described with respect to FIGS. 7A-7C are merely illustrative. Other variations are possible.

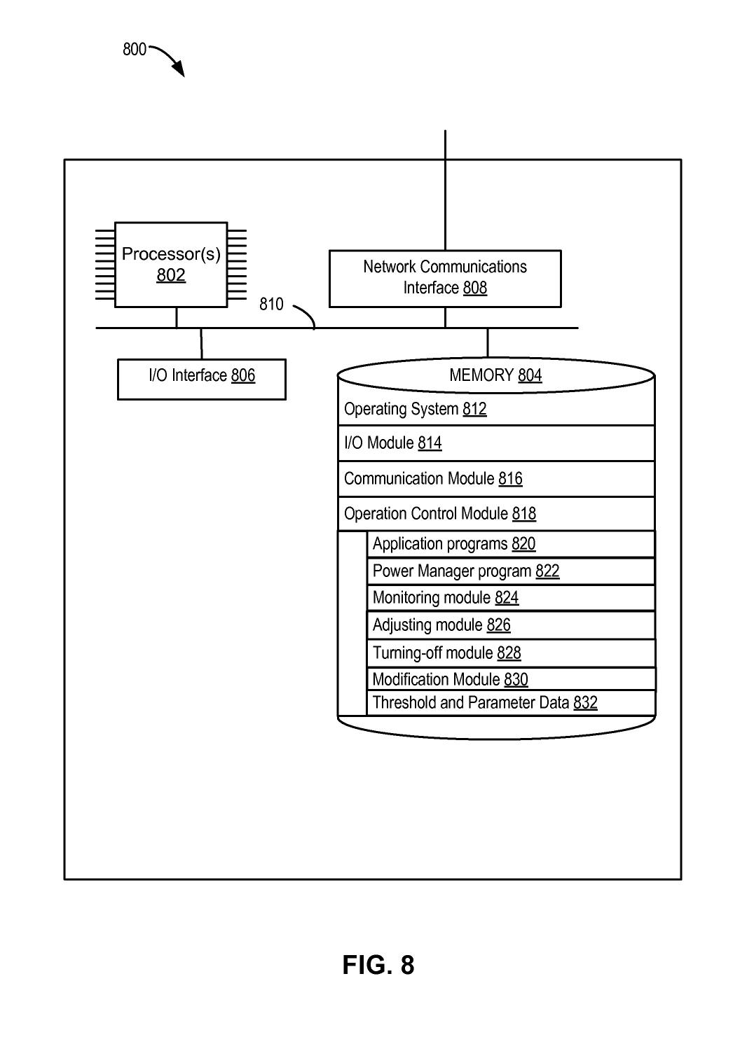

FIG. 8 is a block diagram of a system 800 for implementing the method of controlling power saving as described above, in accordance with some embodiments. In some embodiments, the system 800 is one of: a mobile device, a PDA, a smartphone, a handheld computer, and a tablet computer.

As shown in FIG. 8, the system 800 includes one or more processing units (also called herein “processors”) 802, memory 804, an input/output (I/O) interface 806, and a network communications interface 808. These components communicate with one another over one or more communication buses or signal lines 810. In some embodiments, the memory 804, or the computer readable storage media of memory 804, stores programs, modules, instructions, and data structures including all or a subset of: an operating system 812, an I/O module 814, a communication module 816, and an operation control module 818. The one or more processors 802 are coupled to the memory 804 and operable to execute these programs, modules, and instructions, and reads/writes from/to the data structures.

In some embodiments, the processing units 802 include one or more microprocessors, such as a single core or multi-core microprocessor. In some embodiments, the processing units 802 include one or more general purpose processors. In some embodiments, the processing units 802 include one or more special purpose processors.

In some embodiments, the memory 804 includes high-speed random access memory, such as DRAM, SRAM, DDR RAM or other random access solid state memory devices. In some embodiments the memory 804 includes non-volatile memory, such as one or more magnetic disk storage devices, optical disk storage devices, flash memory devices, or other non-volatile solid state storage devices. In some embodiments, the memory 804 includes one or more storage devices remotely located from the processing units 802. The memory 804, or alternately the non-volatile memory device(s) within the memory 804, comprises a computer readable storage medium.

In some embodiments, the I/O interface 806 couples one or more input/output devices, such as displays, a keyboards, touch screens, speakers, and microphones, to the I/O module 814 of the system 800. The I/O interface 806, in conjunction with the I/O module 814, receive user inputs (e.g., voice input, keyboard inputs, touch inputs, etc.) and process them accordingly. The I/O interface 506 and the I/O module 814 also present outputs (e.g., sounds, images, text, etc.) to the user according to various program instructions implemented on the system 800.

In some embodiments, the network communications interface 808 includes wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends RF signals and/or optical signals from/to communications networks and other communications devices. The wireless communications may use any of a plurality of communications standards, protocols and technologies, such as GSM, EDGE, CDMA, TDMA, Bluetooth, WiFi, VoIP, Wi-MAX, or any other suitable communication protocol. The network communications interface 808 enables communication between the system 800 with networks, such as the Internet, an intranet and/or a wireless network, such as a cellular telephone network, a wireless local area network (LAN) and/or a metropolitan area network (MAN), and other devices. The communications module 816 facilitates communications between the system 800 and other devices (e.g., the first client device and the second client device) over the network communications interface 808.

In some embodiments, the operating system 502 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

In some embodiments, the system 800 is implemented on a portable electronic device (e.g., a smart phone, a mobile phone, a tablet computer, etc.). It should be noted that the system 800 is only one example, and that the system 800 may have more or fewer components than shown, may combine two or more components, or may have a different configuration or arrangement of the components. The various components shown in FIG. 8 may be implemented in hardware, software, firmware, including one or more signal processing and/or application specific integrated circuits, or a combination of thereof.

In FIG. 8, the operation control module 818 includes various application programs 820, a power manager program 822. The power manager program 822 includes one or more function modules (e.g., monitoring module 824, adjusting module 826, turning-off module 828, modification module 830, and other function modules, etc.). As shown in FIG. 8, the system 800 stores the operation control module 818 in the memory 804. In some embodiments, the operation control module 818 further includes threshold and parameter data 832 such as the correspondence between the current remaining charge and the various parameter values, the threshold battery levels for setting the maximum and minimum parameter values, the threshold battery levels for turning on or off various user applications and/or device functions, etc. In some embodiments, the operation control module 818 optionally includes one or more other modules (not shown) to provide other related functionalities described herein. Details on the structures, functions, and interactions of the operation control module 818 are provided with respect to FIGS. 1-7C and accompanying descriptions.

The sequence numbers of the embodiments of the present invention mentioned above are merely for the sake of description, and do not represent the advantages or disadvantages of the embodiments.

Those skilled in the art may understand that all or some of the steps of the embodiments mentioned above may be implemented by hardware, and may also be implemented by a program instructing relevant hardware, and the program may be stored in a computer readable storage medium, and the storage medium mentioned above may be a random access memory, a magnetic disk, or an optical disk, and so on.

What are described above are merely preferred embodiments of the present invention and are not used to limit the present invention, and any modifications, equivalent substitutions, improvements and so on made within the spirit and principles of the present invention shall all be contained in the protection scope of the present invention.

What is claimed is:

1. A method for controlling power saving, comprising:
at a mobile device having one or more processors and memory:
monitoring a current amount of remaining charge in a battery of the mobile device; and
adjusting, automatically, without user intervention, a respective operation of the mobile device according to the monitored current amount of remaining charge, the adjusting comprising at least one of: changing a current value of a respective device parameter of the mobile device, determining whether to turn off a respective user application that is currently active on the mobile device, and determining whether to turn off a respective device function that is currently provided on the mobile device, according to the monitored current amount of remaining charge.

2. The method of claim 1, wherein the respective device parameter of the mobile device includes at least one of a screen display luminance and a screen standby time, and changing the current value of the respective device parameter of the mobile device comprises setting a current screen display luminance or a current screen standby time in accordance with a predetermined function of the monitored current amount of remaining charge.

3. The method of claim 1, wherein changing the current value of the respective device parameter of the mobile device according to the monitored current amount of remaining charge in the battery further comprises:
in accordance with a determination that the monitored current amount of remaining charge is less than a pre-determined threshold value, setting the current value of the respective device parameter of the mobile device to a predetermined minimum parameter value; and
in accordance with a determination that the monitored current amount of remaining charge is not less than the pre-determined value, obtaining a predetermined value of the respective device parameter corresponding to the monitored current amount of remaining charge by looking up a correspondence between the amount of remaining charge and the device parameter using the monitored current amount of remaining charge, and changing the current value of the respective device parameter of the mobile device to the obtained predetermined value of the respective device parameter.

4. The method according to claim 1, wherein determining whether to turn off the respective user application on the mobile device according to the monitored current amount of remaining charge in the battery further comprises:
turning off the respective user application that is currently active on the mobile device in accordance with a determination that the monitored current amount of remaining charge is less than a pre-determined threshold value; and
keeping a respective turned-on state of the respective user application that is currently active on the mobile device unchanged in accordance the monitored current amount of remaining charge is not less than the pre-determined threshold value.

5. The method according to claim 1, wherein the respective device function comprises at least one of Bluetooth, WiFi, and cellular data network communication functions, and wherein determining whether to turn off the respective device function on the mobile device according to the monitored current amount of remaining charge in the battery further comprises:
turning off the respective device function that is currently active on the mobile device in accordance with a determination that the monitored current amount of remaining charge is less than a pre-determined threshold value; and
keeping a respective turned-on state of the respective application that is currently active on the mobile device unchanged in accordance the monitored current amount of remaining charge is not less than the pre-determined threshold value.

6. The method of claim 1, further comprising:
providing a modification interface to a user that facilitates the user in modifying an existing relationship or establishing a new relationship between the respective operation of the mobile device and a current status of the battery.

7. The method of claim 1, wherein turning off the respective user application that is currently active on the mobile device comprises:
checking a respective setting state of the user application that is currently active on the mobile device;
keeping a respective turned-on state of the user application that is currently active on the mobile device unchanged in accordance with a determination that the respective setting state of the user application is a turning-off-prohibited state; and
turning off the user application that is currently active on the mobile device in accordance with a determination that the respective setting state is a turning-off-permitted state.

8. A system, comprising:
one or more processors; and
memory having instructions stored thereon, the instructions, when executed by the one or more processors, cause the processors to perform operations comprising:
monitoring a current amount of remaining charge in a battery of a mobile device; and
adjusting, automatically, without user intervention, a respective operation of the mobile device according to the monitored current amount of remaining charge, the adjusting comprising at least one of: changing a current value of a respective device parameter of the mobile device, determining whether to turn off a respective user application that is currently active on the mobile device, and determining whether to turn off a respective device function that is currently provided on the mobile device, according to the monitored current amount of remaining charge.

9. The system of claim 8, wherein the respective device parameter of the mobile device includes at least one of a screen display luminance and a screen standby time, and changing the current value of the respective device parameter of the mobile device comprises setting a current screen display luminance or a current screen standby time in accordance with a predetermined function of the monitored current amount of remaining charge.

10. The system of claim 8, wherein changing the current value of the respective device parameter of the mobile device according to the monitored current amount of remaining charge in the battery further comprises:
in accordance with a determination that the monitored current amount of remaining charge is less than a pre-determined threshold value, setting the current value of the respective device parameter of the mobile device to a predetermined minimum parameter value; and
in accordance with a determination that the monitored current amount of remaining charge is not less than the pre-determined value, obtaining a predetermined value of the respective device parameter corresponding to the monitored current amount of remaining charge by looking up a correspondence between the amount of remaining charge and the device parameter using the monitored current amount of remaining charge, and changing the current value of the respective device parameter of the mobile device to the obtained predetermined value of the respective device parameter.

11. The system of claim 8, wherein determining whether to turn off the respective user application on the mobile device according to the monitored current amount of remaining charge in the battery further comprises:
turning off the respective user application that is currently active on the mobile device in accordance with a determination that the monitored current amount of remaining charge is less than a pre-determined threshold value; and
keeping a respective turned-on state of the respective user application that is currently active on the mobile device unchanged in accordance the monitored current amount of remaining charge is not less than the pre-determined threshold value.

12. The system of claim 8, wherein the respective device function comprises at least one of Bluetooth, WiFi, and cellular data network communication functions, and wherein determining whether to turn off the respective device function on the mobile device according to the monitored current amount of remaining charge in the battery further comprises:
turning off the respective device function that is currently active on the mobile device in accordance with a determination that the monitored current amount of remaining charge is less than a pre-determined threshold value; and
keeping a respective turned-on state of the respective application that is currently active on the mobile device unchanged in accordance the monitored current amount of remaining charge is not less than the pre-determined threshold value.

13. The system of claim 8, further comprising:
providing a modification interface to a user that facilitates the user in modifying an existing relationship or establishing a new relationship between the respective operation of the mobile device and a current status of the battery.

14. The system of claim 8, wherein turning off the respective user application that is currently active on the mobile device comprises:
checking a respective setting state of the user application that is currently active on the mobile device;
keeping a respective turned-on state of the user application that is currently active on the mobile device unchanged in accordance with a determination that the respective setting state of the user application is a turning-off-prohibited state; and
turning off the user application that is currently active on the mobile device in accordance with a determination that the respective setting state is a turning-off-permitted state.

15. A non-transitory computer-readable medium having instructions stored thereon, the instructions, when executed by one or more processors, cause the processors to perform operations comprising:
monitoring a current amount of remaining charge in a battery of a mobile device; and
adjusting, automatically, without user intervention, a respective operation of the mobile device according to the monitored current amount of remaining charge, the adjusting comprising at least one of: changing a current value of a respective device parameter of the mobile device, determining whether to turn off a respective user application that is currently active on the mobile device, and determining whether to turn off a respective device function that is currently provided on the mobile device, according to the monitored current amount of remaining charge.

16. The computer-readable medium of claim 15, wherein the respective device parameter of the mobile device includes at least one of a screen display luminance and a screen standby time, and changing the current value of the respective device parameter of the mobile device comprises setting a current screen display luminance or a current screen standby time in accordance with a predetermined function of the monitored current amount of remaining charge.

17. The computer-readable medium of claim 15, wherein changing the current value of the respective device parameter of the mobile device according to the monitored current amount of remaining charge in the battery further comprises:
in accordance with a determination that the monitored current amount of remaining charge is less than a pre-determined threshold value, setting the current value of the respective device parameter of the mobile device to a predetermined minimum parameter value; and
in accordance with a determination that the monitored current amount of remaining charge is not less than the pre-determined value, obtaining a predetermined value of the respective device parameter corresponding to the monitored current amount of remaining charge by looking up a correspondence between the amount of remaining charge and the device parameter using the monitored current amount of remaining charge, and changing the current value of the respective device parameter of the mobile device to the obtained predetermined value of the respective device parameter.

18. The computer-readable medium of claim 15, wherein determining whether to turn off the respective user application or the respective device function on the mobile device according to the monitored current amount of remaining charge in the battery further comprises:
turning off the respective user application or device function that is currently active on the mobile device in accordance with a determination that the monitored current amount of remaining charge is less than a pre-determined threshold value; and
keeping a respective turned-on state of the respective user application or device function that is currently active on the mobile device unchanged in accordance the monitored current amount of remaining charge is not less than the pre-determined threshold value.

19. The computer-readable medium of claim 15, wherein the operations further comprise:
providing a modification interface to a user that facilitates the user in modifying an existing relationship or establishing a new relationship between the respective operation of the mobile device and a current status of the battery.

20. The computer-readable medium of claim 15, wherein turning off the respective user application that is currently active on the mobile device comprises:
checking a respective setting state of the user application that is currently active on the mobile device;
keeping a respective turned-on state of the user application that is currently active on the mobile device unchanged in accordance with a determination that the respective setting state of the user application is a turning-off-prohibited state; and
turning off the user application that is currently active on the mobile device in accordance with a determination that the respective setting state is a turning-off-permitted state.
